(19) United States
(12) Patent Application Publication
(10) Pub. No.: US 2004/0250623 A1
(43) Pub. Date: Dec. 16, 2004

(54) Method and device for sensing health and condition of a bearing through the lubrication port of a machine

(76) Inventors: Steve Walker, Madison, CT (US); Stewart Walker, Barrington, RI (US); George William Nickerson, State College, PA (US); Lewis Cavine Watt, State College, PA (US)

Correspondence Address: BURNS & LEVINSON LLP, 1030 15TH STREET NW, SUITE 300, WASHINGTON, DC, 20005-1501, US

(21) Appl. No.: 10/816,355

(22) Filed: Apr. 1, 2004

Related U.S. Application Data
(63) Continuation-in-part of application No. 10/406,694, filed on Apr. 3, 2003.

(51) Int. Cl. G01N 11/00

(52) U.S. Cl. 73/593

(57) ABSTRACT

An online bearing monitor is provided that is threaded to the lubrication port of a bearing of a machine. The online bearing monitor of the present invention contains a temperature and vibration sensor, a lubrication level sensor optionally detachably coupled to the lubrication device, on board intelligence, and both wire and wireless electronics. The monitor provides for two-way communication to detect the lubrication and maintenance needs of a machine bearing. The monitor processes and stores temperature and vibration signals on site to determine corrective measures. The corrective measures can be conveyed wire or wirelessly to remote stations.

### PRIORITY

This application is a continuation-in-part of U.S. application Ser. No. 10/406,694, filed Apr. 3, 2003, and to the extent legally applicable claims priority therefrom.

### FIELD OF INVENTION

The present invention relates to a method and device for sensing the health and condition of a machine. More particularly, it relates to a device attached to the lubrication port of a bearing for detecting and processing the condition of a bearing. In addition, it relates to the detection and processing of the lubrication needs and maintenance needs of a bearing.

### BACKGROUND OF THE INVENTION

In typical industrial and manufacturing facilities, various types of machinery are employed at various stages of the production process. Such machines generally function to provide the power and motive force necessary to achieve the end product or carry out a process.

From a production viewpoint, it is desirable to maintain the machinery in good operating condition in order to avoid unproductive downtime and to reduce loss of profits due to machine failure. A typical plant maintenance program will involve activities for monitoring the operating condition of plant machinery so that the health and condition of the machines can be maintained at high levels in order to reduce the number and extent of machine failures. Therefore, it is desirable to know that a machine is experiencing a change in condition or about to experience failure prior to the actual failure.

Portable instruments are often employed to periodically monitor various operating conditions of industrial machinery. These portable instruments, which are often referred to as data collectors or data analyzers, typically include a vibration transducer attached in some way to a machine and connected electronically to what is essentially a hand-held computer.

The maintenance technician places the vibration transducer against a predefined test point of the machine. The resultant machine vibration signal produced by the transducer is provided to the data collector where the data is processed and stored for later downloading to a host computer. The host computer then analyzes the vibration data to discern the needs of the bearing or diagnose other anomalous conditions, if any.

Attempts have been made in the prior art to provide enclosures for protecting various instruments and electronic devices. However, none of the enclosures resulting from these attempts are adapted to be attached to a lubrication port to allow for, e.g., (1) the detection of a potential problem with a bearing before failure has occurred, (2) the processing of the detected information at or near the machine site, and (3) either the pass through of lubricant to the bearing or causing lubrication to the bearing to respond to the detected problem.

For example, U.S. Pat. No. 5,952,803 is one approach to a machine monitoring device attached directly to the machine. The monitor includes the electronics and sensors necessary to sense, analyze, and store one or more of the machine's operating characteristics, including vibration, temperature, and flux. The monitor case or enclosure is configured to minimize attenuation of machine parameters or operating characteristics (such as vibration and temperature) between the bearing housing and sensors. The machine data stored by the monitor is then downloaded and uploaded to or from the monitor when needed. This device is not adapted to connect to the lubrication port to control one of the important functions of moving parts, i.e. lubrication. It is also not able to detect and then process the information it receives on site in order to have two way communication to respond to the problem without the assistance of a human being. The prior art device can only signal that the bearing is operating properly or that the bearing is having a problem.

It is already available in the prior art to obtain an automatic lubricant dispenser as seen in U.S. patent application Ser. No. 08/966,502. It is battery operated and a circuit board is connected between the battery and a motor unit. With such a system, once the machine is turned on, the controller periodically energizes the motor. A motion detector associated with the motor output shaft delivers normally one pulse per revolution of this shaft to the controller which deenergizes the motor after a predetermined number of revolutions, corresponding to the extrusion of a predetermined dose of lubricant from the outlet.

Thus, periodically the motor is started and then, after a predetermined dose is expelled from the outlet, the motor is stopped. Actual displacement of the piston is monitored rather than simple motor-energization time, since the viscosity of the lubricant will change with temperature and the back pressure can vary, making the amount of lubricant pumped out only weakly related to the actual pumping time.

There is a universal dissatisfaction within the industry with current techniques, processes, and hardware that deal with physical asset maintenance and automatic lubrication of bearings. It would be desirable in the industry, for example, for the operator to know that the bearing is starting to become low on lubrication or that there is too much lubrication and to have two-way communication from the sensor to an operator and back to the lubricator to adjust for more or less lubrication or to have the monitor automatically direct the lubrication device. What is needed is a monitor capable of housing wire and/or wireless electronics and sensors for monitoring the health and maintenance of a machine and an ability to correct any lubrication problems detected.

The present invention is easy to install, saves inspection man-hour time, and time for actual manual lubrication, thereby delivering immediate and long-term dollar savings. There are improvements in uptime of machinery, which is a direct cost payback. A wire and/or wireless and automated system is provided that will reduce staff requirements and remove ineffective maintenance techniques resulting in reduced resource consumption and dollars expended. The monitor is adapted to be easily installed on and removed from a machine and allows for easy access to the wire and/or wireless technology and sensors located within the enclosure. In addition, it is rugged and capable of affording suitable protection for wire and/or wireless technology and sensors from harsh environmental elements.

It is therefore an object of the present invention to provide an improved automatic lubrication dispensing method that is signaled by the online bearing monitor to lubricate when the bearing is in need of lubrication. Another object of the present invention is to provide such an improved automatic lubrication dispensing method which overcomes the above-given disadvantages, that is which provides the lubrication to the type of operation—intermittent or continuous—of the machine to which it is connected by way of a monitor having a smart sensor.

It is also an object of the present invention to provide a monitor with a smart sensor to detect and respond to the needs of the bearing. Another object of the present invention is to monitor the level of lubrication in the luber that is available for the bearing. It is a further object of the present invention to store and use at a future time the information generated from the bearing for diagnostic monitoring of the health and condition of the bearing. It is yet a further object of the present invention to detect and then process the information it receives on site in order to have two way communications to respond to the problem without the assistance of a human being.

### SUMMARY OF THE INVENTION

The online bearing monitor is capable of detecting and then processing data on a platform that is either local or remote using embedded logic and a variety of signal processing approaches, including, but not limited to, simple threshold comparison, time to frequency domain transforms and power spectrum binning, time domain analysis, fuzzy logic, neural networks, or a host of other computational constructs. In accordance with a preferred embodiment of the present invention, an online bearing monitor is provided that is threaded to the lubrication port of a bearing of a machine. The online bearing monitor of the present invention contains a temperature and vibration sensor, a lubrication level sensor optionally detachably coupled to the lubrication device, on board computer capability, and either or both wire and wireless electronics. This configuration provides a platform on which can be operated any of a number of electronic and/or digital signal processing logics and software techniques for combining vibration data, derived vibration data, temperature data, and other information as a basis for operating the automatic lubing subsystem of the device.

Alternatively, the platform can be used for preprocessing the data. In this configuration final processing and application of a decision making algorithm that issues instructions can take place remotely from a central monitoring station, which frequently comprises a PC (computer).

The bearing monitor is simple to mount on machinery by attaching the monitor to the bearing's existing lubrication port through a standard NPT thread, whence it can transmit critical performance information to any remote data appliance receiving device, including, but not limited to, a local personal computer, hand held wireless personal data appliance, or any Internet or other hard wired or wireless receiving device.

Various sensors sense information such as vibration and heat signals from the bearing. The present invention also has sensors that monitor the level of lubrication available for the bearing in the luber. To enhance the ability of the online bearing monitor to sense machine operating characteristics, the sensor is adhered to a shaft that connects the lubrication port of the bearing to a lubrication device. The sensor can be mounted to the shaft in a variety of ways. For example, an adhesive can be used to secure the sensor to the pipe. Machine operating characteristics are then detected from the bearing, through the engagement surface of the shaft to the sensor. The shaft also functions to allow lubrication from the lubrication device to the bearing as needed. Software comprising diagnostic algorithms optionally contained within the online bearing monitor, or alternatively in the central monitoring station, will be used to process and analyze the information transmitted from each bearing by the sensors. Such software is known in the art, either being set forth in patents and publications or being held proprietarily by specific vendors.

In one embodiment of the invention, the lubrication level sensors are mounted directly to the luber and transmit the data to the online bearing monitor by wire. In another embodiment of the invention, the level sensor is clamped onto the luber as a separate device. The level sensor can be attached to the luber by mechanical bracket, strap, adhesive, or any other suitable clamping mechanism. The level sensor optionally can have its own power source and means for wirelessly transmitting data independently of other sensors.

A circuit board containing wire and/or wireless electronics is also mounted near the shaft within the online bearing monitor. A support board is constructed within the online bearing monitor. The support board functions to inhibit movement of the wire and/or wireless electronics. To communicate with a peripheral device, such as a portable data collector or notebook computer, a wireless technology communication device is placed within the online bearing monitor.

The information detected from the sensors is optionally processed within the online bearing monitor and the processed information is sent to a remote station to indicate to an operator the status of the bearing and the amount of lubrication in the luber. The operator can know the current status of the bearing and the lubrication level in the luber and take action himself manually or through a computer. The online bearing monitor will issue a warning to the remote computer and operator when a predetermined threshold has been exceeded and will either instruct the operator to take action or instruct the luber to adjust the lubrication.

The sensors are “smart” sensors as the information is processed within the online bearing monitor. The human operator can be totally eliminated as the online bearing monitor can automatically give instruction to a luber connected to the opposite end of the monitor to increase or decrease lubrication needed for the bearing. The lubrication actually passes through the online bearing monitor from the luber to the bearing. The online bearing monitor can then sense that the lubrication needs of the bearing has been satisfied, process this information as feedback to the luber to either stop lubrication or continue lubrication at set perimeters. All of this processed information is continuously transmitted to a remote computer station for a human operator to review and intervene should he so desire. Additionally, the level of lubrication in the luber and the fact that the luber is operating properly is also transmitted to the operator.

As the online bearing monitor is threaded to the lubrication port of the bearing, the monitor provides constant feedback control to the lubrication dispensing system. Therefore, the maintenance needs of the bearing of the machine are continuously detected and performed automatically prior to any failure of the bearing of the machine.

In a preferred embodiment of the invention, the online bearing monitor is self-contained in sensors, both wire and wireless technology, and electrical power. A 6 or 12 volt DC battery pack provides all the electrical power needed. However, the online bearing monitor may include a flat formed on the inner wall of the housing for supporting the connection of an external conduit if desired. The external conduit could be used to supply the online bearing monitor with electrical power, or external sensor signals, or both.

### BRIEF DESCRIPTION OF THE DRAWINGS

The above and other objects, features, and advantages will become more readily apparent from the following description, reference being made to the accompanying drawings in which:

FIG. 1A is an orthogonal schematic side view of the online bearing monitor according to the present invention;

FIG. 1B is an exploded orthogonal schematic cross-sectional side view of the online bearing monitor showing the relational arrangement of the components;

FIG. 2A is an orthogonal cross-sectional side view of the online bearing monitor according to one embodiment of the present invention;

FIG. 2B is an orthogonal cross-sectional side view of the online bearing monitor according to another embodiment of the present invention; and

FIG. 3 is a flow diagram showing how the sensed data are conveyed to remote sites.

### IDENTIFICATION OF ITEMS IN THE FIGURES

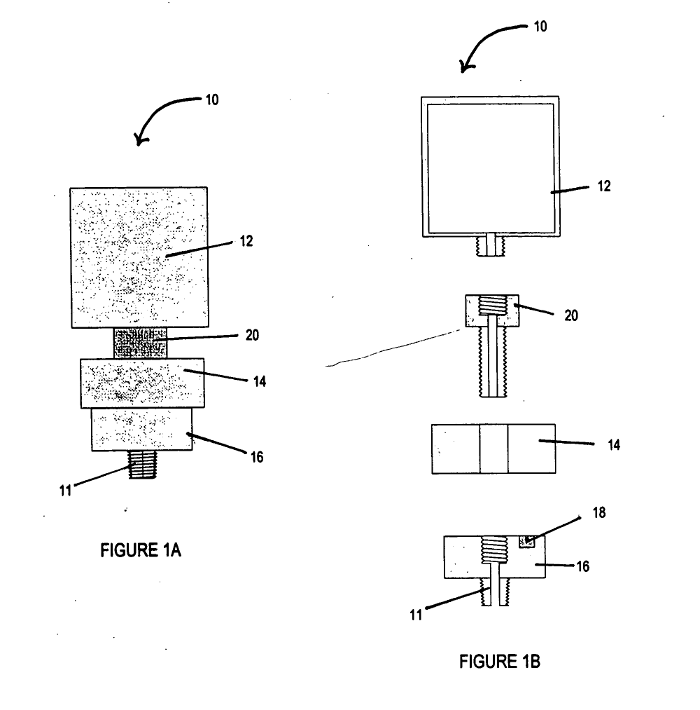

FIG. 1A

10—online bearing monitor

11—threaded connector portion for engaging the oiling port

12—luber

14—electronic data-gather/data-processing and sending segment

16—transducer portion containing vibration and temperature sensors

20—threaded connector portion

FIG. 1B

10—online bearing monitor

11—threaded connector portion for engaging the oiling port

12—luber

14—electronic data-gather/data-processing and sending segment

16—transducer portion containing vibration and temperature sensors

18—transducer/sensor(s)

20—threaded connector portion

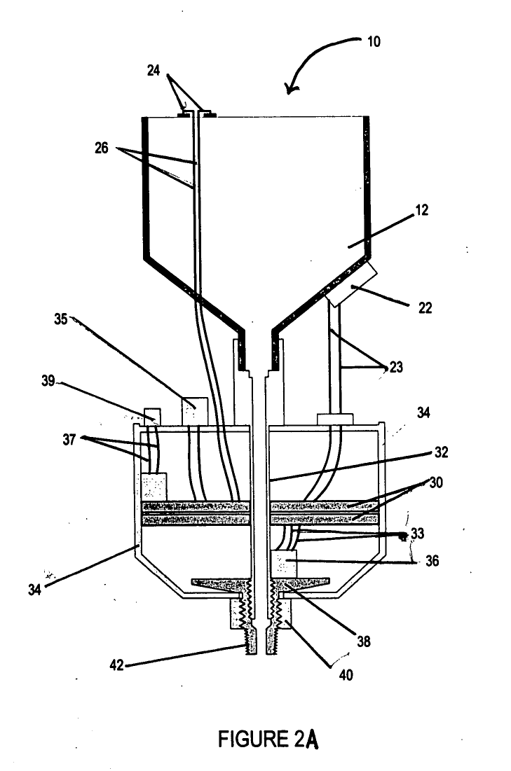

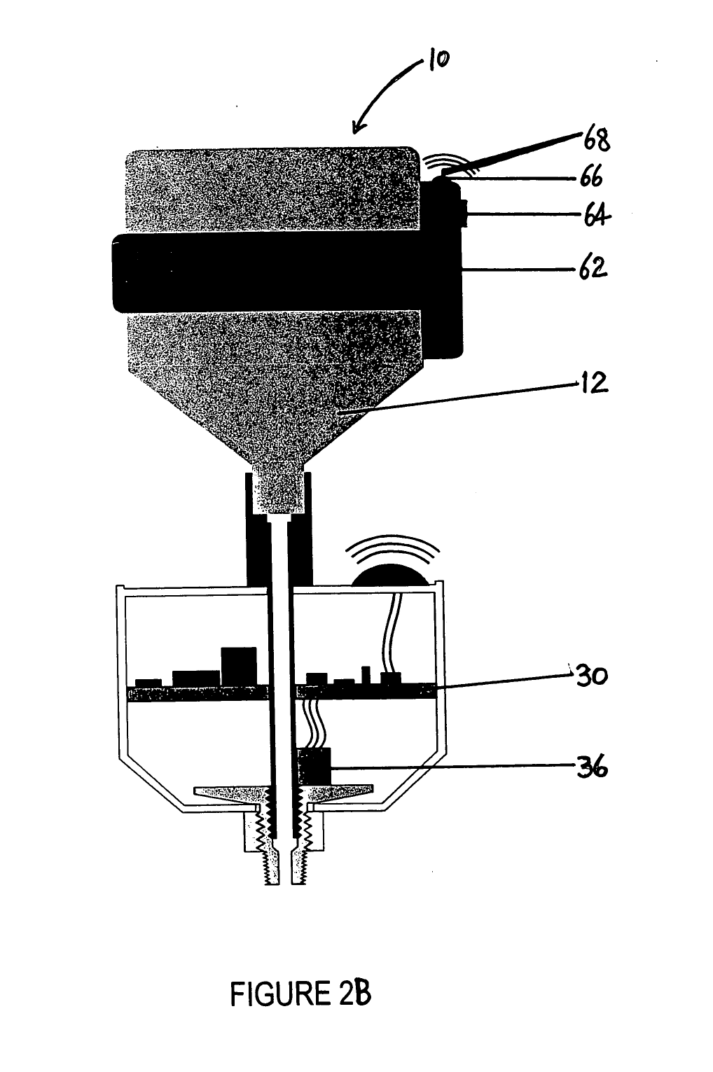

FIG. 2A

10—online bearing monitor

12—luber

22—lubricant level sensor

23—wires from level sensor to control circuits

24—on/off valve for lubricant flow control

26—wires communicating from on/off valve to control circuits

30—circuit boards

32—central shaft (hollow)

33—wires

34—rigid external housing

35—power source

36—transducer module with sensor(s)

37—wires

38—flange plate support for sensor/transducers

39—external antenna

40—nut

42—NPT threaded nipple

FIG. 2B

62—lubricant lever sensor assembly

64—power source

66—lever sensor

68—transmitter

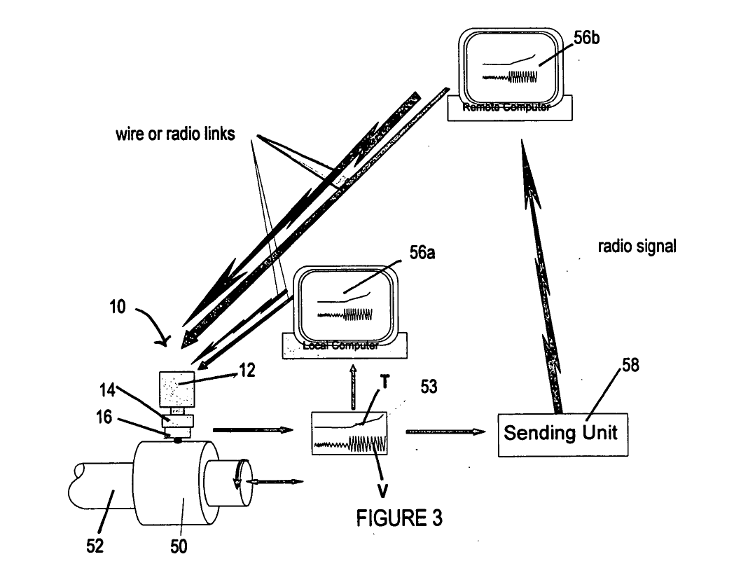

FIG. 3

10—online bearing monitor

12—luber

14—electronic data-gather/data-processing and sending segment

16—transducer portion containing at least vibration and temperature sensing devices

50—bearing

52—shaft inside of bearing

53—data stream

56a, 56b—computers

58—external wireless amplifying/sending unit

### DETAILED DESCRIPTION OF THE PREFERRED EMBODIMENTS

The present invention provides a device and method for detecting data related to the health of a bearing, processing detected data, determining lubrication and lubrication supply data, and using data and processed data either to inform a human operator of a necessary intervention or to generate and automatic response, usually comprising injecting additional lubrication into the bearing. The online bearing monitor of the present invention is alternatively capable of processing data locally using embedded logic and a variety of signal analysis approaches, including, but not limited to simple threshold comparison, time to frequency domain transforms, time domain analysis, fuzzy logic, neural networks, or a host of other computational constructs.

Microelectronics technology enables local processing at low cost and in compact implementations. Alternatively, it is capable of processing remotely either raw data or data preprocessed in the monitor. Methods of processing the data to extract useable information are known in the art and can be found either in patents or publications or as proprietary software supplied from vendors skilled in the art.

In accordance with a preferred embodiment of the present invention, a wired or wireless online bearing monitor is designed to be screwed into the lubrication port of a bearing of a machine. The online bearing monitor of the present invention contains temperature and vibration transducers or sensors, lubrication level transducers or sensors, on-board intelligence, and both wire and wireless electronics. The online bearing monitor can in addition have a shock pulse monitor for vibration analysis and a sensor assembly for sensing and measuring shaft speed.

The online bearing monitor mounts on machinery by attaching it to an existing threaded lubrication port. It can transmit critical bearing-performance information to any remote data appliance receiving device, including, but not limited to a local personal computer, hand held wireless personal data appliance, or any Internet or other wire or wireless receiving device. Software with diagnostic algorithms contained within the online bearing monitor or in the central monitoring station can be used to process and analyze the information transmitted from each bearing using transducers and both wire and wireless technology. Optionally, instead of transmitting raw vibration data to a remote processing device, a bearing's locally produced health evaluation is transmitted with periodic corroborative raw data to the remote processing device as desired. To communicate with a peripheral device, such as a portable data collector or notebook computer, the monitor may incorporate a wire and/or a wireless technology communication system.

FIG. 1A is a schematic side view of the online bearing monitor invention 10. The online bearing monitor 10 consists of an electronic data-gather/data-processing and sending segment 14, a transducer portion 16 containing vibration and temperature sensors, a threaded connector portion 20 having a hole communicating therethrough, and a standard NPT threaded portion 11 for engaging the oiling port most adjacent a bearing portion of a machine, said bearing supporting a rotating and/or reciprocating shaft. The online bearing monitor 10 is attached to a luber 12. The main parts shown in FIG. 1A are arranged more or less concentrically in relation to one another.

The main portion of the invention 10 comprises the transducer portion 16, with threaded segment 11, the electronics portion 14 and the threaded shaft portion 20 which holds the main components of the wireless online monitor 10 together. The luber 12 connects to the online bearing monitor 10 and to the lubricant passageways communicating therethrough.

FIG. 1B is an exploded or disassembled cross-sectional schematic view of the invention shown in FIG. 1A. Transducers 18 in the sensor portion 16 detect vibrations and temperature changes in the bearing and convey the sensed data to the electronics package 14 from which signals can be sent to remote stations. In overall construction, the online bearing monitor 10 comprises the threaded shaft component 20 and the sensor package 16 threaded together with the electronics package 14 secured between them. The transducer portion 14 contains the actual transducer 18, or transducers, for monitoring combinations of parameters, primarily temperature and vibration in one or more axes.

During operation, the online bearing monitor 10 is affixed to a bearing (not shown) by means of the threaded portion 11 that conforms with the National Pipe Thread (NPT) standard typically used on grease nipples or other oiling ports used with machine bearings. Vibration and temperature data received by the transducers 18 in the sensor segment 16 are conveyed by wires to the electronics package 14 which processes the data to determine the maintenance and lubrication needs of the bearing. The programming software contained in the electronics package 14 determines whether to send a signal to the luber 12 or to a remote station, or both. A signal to the automatic lubricator can activate the lubricator to supply lubricant to the bearing, by way of the internal channels provided, or it might also send an alarm or sound an alarm so that a technician will know to perform maintenance or supply lubricant to the bearing as needed.

FIG. 2A is an orthogonal cross-sectional side view of the online bearing monitor 10. One or more circuit boards 30 are affixed around a hollow-centered central shaft 32 (corresponding to 20 in FIGS. 1A and 1B) and housed within a rigid housing 34 made of materials such as metal or plastic. Transducer 36 is firmly affixed to flange plate 38 which is integral with the NPT threaded nipple 40 by which the online bearing monitor 10 is attached to a lubrication port on the bearing being monitored. The hollow central shaft 32 is made of metal, preferably stainless steel. The flange plate 38 is secured to the housing 34 by means of nut 40. The threaded nipple 42 is integral with the flange 38, and its threads conform to the NPT standard or other appropriate thread or attachment type as might secure the online bearing monitor 10 to a bearing housing through which lubricant might ordinarily be gravity fed to a bearing. Central shaft 32 screws into the combination flange 38 and NPT nipple 42.

In one embodiment of the invention, as shown in FIG. 2A, a luber 12 is affixed to the online bearing monitor 10. The luber 12 consists of a reservoir of lubricant as well as a lubrication level sensor 22 having wires 23 connecting it to the control circuits on the circuit boards 30 which are discussed in more detail below. The level sensor 22 can be of any suitable type, such as an ultrasonic sensor that uses active high frequency sound waves to detect, by reflection, the top surface of the lubricant in the reservoir part of the luber 12, or it can be a passive pressure type sensor that detects the column weight of the lubricant fluid above the sensor in the reservoir. The luber 12 also includes an electrically controlled on/off valve 24 which communicates with the control circuits contained on the circuit boards 30 by way of the wires 26. Temperature and vibration data from the transducer package 36 are conveyed to the circuit boards 30 by way of wires 33. The circuitry on the one or more boards 30 is supplied with power from power source 35, such as a battery or battery pack or other electrical power source as might be suitable such as a low-voltage AC or DC transformer.

In another embodiment of the invention, as shown in FIG. 2B, a luber 12 has a reservoir of lubricant and a lubrication level sensor assembly 62 operatively coupled to the luber 12 by clamping mechanism, including, but not limited to mechanical bracket, strap, and adhesives. The sensor assembly is operatively and optionally detachably coupled to a lubrication device for detecting and generating a signal responsive to indicate the physical level of the lubricant in the lubrication device to determine that the lubrication device is indeed working and if it needs replacement.

The level sensor assembly 62 includes its own power resource 64, at least one level sensor 66 for generating a signal responsive to physical properties of the luber 12, and a transmitter 68 for transmitting signal to local or remote processing device.

Preferably, the level sensor assembly 62 contains a plurality of level sensors 66 for measuring different parameters of the physical properties of the lubricant, such as the level of the lubricant temperature, viscosity, and chemical characteristics. Circuitry is provided for remotely powering the at least one level sensor 66 and for remotely detecting the signal.

The level sensor assembly 62 is capable of wirelessly transmitting data independently of the temperature and vibration transducer 36. Furthermore, the level sensor assembly 62 is installed totally independent of connection to any other heat and vibration sensors, therefore, reduces the bandwidth required to communicate to the higher level systems.

Radio frequency signals being sent to a site that is remote from the circuit boards 30 or, more generally, from the online bearing monitor 10, are conveyed upon wires 37 to external antenna 39. Whereas the online bearing monitor 10 might be programmed to sound a local alarm in the event of a need for bearing maintenance, the inventors also envision processed data from the wireless online monitor being conveyed to one or more remote locations. Power source 64 could be a battery or battery pack or other electrical power source as might be suitable.

FIG. 3 shows the online bearing monitor 10 affixed to a bearing 50 (or bearing housing or other bearing support) supporting shaft 52 which has rotary and/or reciprocating motion. More generally, FIG. 3 illustrates the flow of processed data from the online bearing monitor 10 to one of computers 56a, 56b. The data stream 53 might be sent wirelessly, or by wire, to a local computer 56a or to a distant computer 56b, perhaps by way of one or more amplifying links and/or wireless sending units 58. The vibration and temperatures sensors contained within the sensor portion 16 of the online bearing monitor 10 convey their data to the electronics package 14 which processes and stores the data and either directly triggers the luber 12 to send lubricant to the bearing 50 or conveys the processed data stream 54 to some remote station such as a near-by computer receiver 56a or, by way of a local amplifier and sending unit 58, to one or more distant stations, such as the remote computer 56b situated far distant from the bearing being monitored.

The information gained from the sensor portion 16 is both processed and stored in the wireless online monitor so as to maintain a database that can characterize the performance of the bearing 50 for future use. The local sending unit 58 may also convey the data onto the Internet or other data network so as to be accessible to remotely located interested parties.

An operator situated at the remote computer 56a or 56b may communicate with the online bearing monitor 10 or with the luber so as to cause lubricant to be conveyed to the bearing 50. Alternatively, or simultaneously, the data signal 54 that is conveyed to a remote station such as the computer 56 can itself be used for such purposes as (1) to indicate to a technician that bearing maintenance such as lubrication is needed; (2) providing data recordation from which the performance of a given bearing can be characterized for various future purposes including refinement of the bearing-specific performance that indicates a need for maintenance, lubrication, or replacement; or (3) for accessing high-level remote software that can determine more accurately than can the electronics package 14 the specific needs of a bearing being monitored.

In a preferred embodiment of the invention, the online bearing monitor is self-contained with sensor/transducers, both wire and wireless technology, and electrical power. A 6 to 12 volt DC battery pack provides the electrical power, though it may include a flat on the inner wall of the housing 34 for supporting the connection of an external power conduit as desired. The external conduit could be used to supply the online bearing monitor with electrical power, or external sensor signals, or both.

The online bearing monitor is envisioned as being able to provide constant feedback control to the lubrication dispensing system, thereby ensuring that the maintenance needs of a bearing being monitored can be continuously detected and satisfied prior to any failure.

Information detected from the sensors is processed within the online bearing monitor and is sent to one or more remote stations to indicate to an operator the status of a bearing. The operator can know the current status of the bearing and the level of lubrication in the luber and take action manually or through a computer. The online bearing monitor will issue a warning to the remote computer and operator when a predetermined threshold has been exceeded and will either instruct the operator to take action or instruct the luber to adjust the lubrication. The sensors are “smart sensors” in that the information is processed within the monitor. The monitor can automatically actuate a luber connected to the monitor to increase or decrease lubrication needs of the bearing. All processed information can be continuously transmitted to remote computer stations for human operation to review and intervene as needed. Additionally, the fact that the lubricator is operating properly is also transmitted to the operator.

We claim:

1. An online bearing monitor for controlling the lubricating activity of a bearing luber, comprising:
a) a lubricant level sensor capable of sensing the level of lubricant in the luber;
b) a lubrication flow control mechanism comprising part of the luber and capable of receiving signals to control the flow of lubricant to the bearing;
c) a transducer module comprising at least one online bearing condition sensor;
d) a data gathering and processing segment capable of receiving and processing data from the transducer module and from the lubricant level sensor and capable of producing output data;
e) a platform for data processing capable of receiving the output data from the data gathering and processing segment and comprising computing hardware capable of storing and executing software capable of transforming the output data from the data gathering and processing segment into signals able to cause the lubrication control mechanism to increase or decrease lubricant flow from the luber;
f) a central monitoring station; and
g) a communications system capable of transmitting information in both directions between the data gathering and processing segment and the data processing platform on the one hand and the central monitoring station on the other and between the data processing platform and the lubrication flow control mechanism.

2. The online bearing monitor of claim 1 in which the lubrication flow control mechanism is a piston.

3. The online bearing monitor of claim 2 in which the lubrication level sensor indicates the position of the piston in the luber.

4. The online bearing monitor of claim 1
in which the at least one bearing condition sensor comprises at least a vibration sensor and a temperature sensor.

5. The online bearing monitor of claim 1 additionally comprising a power source.

6. The online bearing monitor of claim 1 in which the communications system is wireless.

7. The online bearing monitor of claim 1 in which the platform for data processing is co-located with the central monitoring station.

8. The online bearing monitor of claim 1 in which the platform for data processing is co-located with the data gathering and processing segment.

9. The online bearing monitor of claim 1 in which the co-located platform for data processing and the data gathering and processing segment are further co-located with the luber.

10. A system for automatically lubricating a bearing comprising:
a) an online bearing monitor capable of monitoring and storing heat and vibration signals from the bearing, processing the heat and vibration signals to determine the bearing's lubrication needs, and transmitting the lubrication needs of the bearing;
b) a lubrication device capable of receiving the bearing's lubrication needs and responding to those needs by providing the necessary amount of lubrication to the bearing; and
c) a sensor assembly operatively coupled to a lubrication device for detecting and generating a signal responsive to physical level of the lubricant in the lubrication device and to whether the lubrication device is operational, and transmitting the signal independently of the bearing's lubrication needs, the sensor assembly comprising:
i) at least one sensor for detecting and generating a signal responsive to physical properties of the lubrication device;
ii) a transmitter for transmitting signal responsive to physical properties of the lubrication device; and
iii) a power source.

11. The system of claim 9 in which the sensor assembly is detachable from the lubrication device.

12. The system of claim 9 in which the transmitter is wireless.

13. A sensor assembly operatively coupled to a lubrication device for detecting and generating a signal responsive to physical level of the lubricant in the lubrication device and to whether the lubrication device is operational, and transmitting the signal independently of the bearing's lubrication needs, the sensor assembly comprising:
i) at least one sensor for detecting and generating a signal responsive to physical properties of the lubrication device;
ii) a transmitter for transmitting signal responsive to physical properties of the lubrication device; and
iii) a power source.

14. The system of claim 13 in which the sensor assembly is detachable from the lubrication device.

15. The system of claim 13 in which the transmitter is wireless.

16. An automatic bearing lubrication system, comprising:
a) a luber;
b) a lubricant level sensor capable of sensing the level of lubricant in the luber;
c) a lubrication flow control mechanism capable of receiving signals to control the flow of lubricant to the bearing;
d) a transducer module comprising at least one online bearing condition sensor;
e) a data gathering and processing segment capable of receiving and processing data from the transducer module and from the lubricant level sensor and capable of producing output data;
f) a platform for data processing capable of receiving the output data from the data gathering and processing segment and comprising computing hardware capable of storing and executing software capable of transforming the output data from the data gathering and processing segment into signals able to cause the lubrication control mechanism to increase or decrease lubricant flow from the luber;
g) a central monitoring station; and
h) a communications system capable of transmitting information in both directions between the data gathering and processing segment and the data processing platform on the one hand and the central monitoring station on the other and between the data processing platform and the lubrication flow control mechanism.

17. The online bearing monitor of claim 16 in which the lubrication flow control mechanism is a piston.

18. The online bearing monitor of claim 17 in which the lubrication level sensor indicates the position of the piston in the luber.

19. The online bearing monitor of claim 16 in which the at least one bearing condition sensor comprises at least a vibration sensor and a temperature sensor.

20. The online bearing monitor of claim 16 additionally comprising a power source.

21. The online bearing monitor of claim 16 in which the communications system is wireless.

22. The online bearing monitor of claim 16 in which the platform for data processing is co-located with the central monitoring station.

23. The online bearing monitor of claim 16 in which the platform for data processing is co-located with the data gathering and processing segment.

24. The online bearing monitor of claim 16 in which the co-located platform for data processing and the data gathering and processing segment are further co-located with the luber.
